(19) United States
(12) Patent Application Publication
(10) Pub. No.: US 2007/0261108 A1
(43) Pub. Date: Nov. 8, 2007

(54) Service Method and Apparatus by Granting Authorization Before Authentication

(75) Inventors: Chih-Jen Lee, Taiwan (TW); Wen-Yao Chang, Taiwan (TW)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/570,365

(22) PCT Filed: Jun. 13, 2005
(86) PCT No.: PCT/JP05/11178

§ 371 Date: Dec. 11, 2006

(30) Foreign Application Priority Data
Jun. 14, 2004 (CN) 200410059240.5

(51) Int. Cl. H04L 29/06

(52) U.S. Cl. 726/5

(57) ABSTRACT

In a service method by granting authorization before authentication, a service processing unit receives a service request that includes authentication information, and provides corresponding service. An authentication unit is used to authenticate the authentication information of the service request. A decision control unit is used to determine whether the service request calls for a service that allows pre-authorization. If affirmative, the decision control unit commands the service processing unit to first provide a partial service, simultaneously commands the authentication unit to authenticate the authentication information, and commands the service processing unit to further provide subsequent service upon successful authentication, and to stop the partial service and reject the service request if otherwise. Hence, under the condition that service security is not affected, authentication waiting time is shortened so as to achieve the effect of a faster response to providing service.

### TECHNICAL FIELD

The invention relates to a service method and apparatus by granting authorization before authentication, more particularly to a service method and apparatus by granting authorization before authentication directed to a service where all information is not instantaneously provided but where authentication is required. During authentication, a partial service is first provided to a user such that, under the condition that information security is not affected, authentication waiting time is shortened so as to result in a faster response to providing service.

### BACKGROUND ART

Due to a rapid development in electronic information exchange technology, more and more information can be exchanged, accessed or backed up among users through electronic equipment (such as the Internet, wireless communications networks, and various electronic devices). In order to prevent information providers (server end) from providing private/classified information to incorrect users, the identity of the user is usually subjected to authentication before granting the user access to information. Therefore, when a user issues a service request to an information server end, authentication information of the user (such as account number, password, credit card number, etc.) is encrypted using security technology and is thereafter sent together with the service request to the information server end. As such, when the server end receives the authentication information, it is necessary to decrypt the authentication information first so that the authentication operation can be conducted. For decryption and authentication usually require a large computing capability, when the information server end is overloaded or has insufficient computing capability, the authentication process will slow down, and a delay in the time for providing the service will occur.

In view of the above, relevant technology directed to attempts to shorten authentication time have been proposed heretofore in the prior art, such as U.S. Patent Publication No. 20030172290 A1, U.S. Pat. No. 6,487,659, Patent Publication No. W00157669 A1, etc. Nevertheless, these authentication technologies share one common problem: It is required to wait for the completion of authentication before service is provided to a user. However, as the authentication speed is still unavoidably affected by the computing capability of the server end, their help to a shorter authentication time is thus limited.

In addition, a direction worthwhile to contemplate is as follows: Service providing can be classified as instantaneous services, where all service or information is instantaneously provided, such as door access control, etc., and continuous services, where all service or information is not instantaneously provided, such as online viewing of films, pay channels, or online listening to music, etc. Therefore, when the service provided by a server end is a continuous service, since such service has a characteristic of providing a portion of information that does not affect information security, and because it is not necessary to wait for the authentication process to be completed before the information can be provided to the user, if it is possible to first provide a partial service to users simultaneous with authentication for these continuous services, the time spent by users in waiting for authentication can be effectively shortened, and the response to providing service becomes faster.

### DISCLOSURE OF INVENTION

Therefore, the object of the present invention is to provide a service method and apparatus by granting authorization before authentication directed to continuous services having a characteristic of providing a portion of information that does not affect information security, thereby resulting in a faster response to providing service.

According to one aspect of the invention, a service method by granting authorization before authentication comprises: (A) receiving a service request, the service request including authentication information; (B) determining whether the service request calls for a service that allows pre-authorization; if affirmative, first providing a partial service and, simultaneous with providing the service, authenticating the authentication information; and (C) upon successful authentication, further providing subsequent service; otherwise, stopping the service and rejecting the service request.

According to another aspect of the invention, a service apparatus by granting authorization before authentication for realizing the above method comprises a service processing unit, an authentication unit, and a decision control unit. The service processing unit is used to receive a service request and to provide a corresponding service, wherein the service request includes authentication information. The authentication unit is connected to the service processing unit, and is used to authenticate the authentication information of the service request. The decision control unit is connected to the service processing unit and the authentication unit. The decision control unit is used to determine whether the service request calls for a service that allows pre-authorization. If affirmative, the decision control unit commands the service processing unit to first provide a partial service, simultaneously commands the authentication unit to authenticate the authentication information, and commands the service processing unit to further provide subsequent service upon successful authentication, and to stop the partial service and reject the service request if otherwise.

According to yet another aspect of the invention, a service method by granting authorization before authentication comprises: (A) receiving a service request, the service request including authentication information; (B) first providing a partial service, and simultaneously authenticating the authentication information; and (C) further providing subsequent service upon successful authentication, and stopping the partial service and rejecting the service request if otherwise.

### BRIEF DESCRIPTION OF DRAWINGS

Other features and advantages of the present invention will become apparent in the following detailed description of the preferred embodiments with reference to the accompanying drawings, of which:

FIG. 1 is a system block diagram of the first preferred embodiment of a service apparatus by granting authorization before authentication according to the present invention;

FIG. 2 is a flowchart of the first preferred embodiment of a service method by granting authorization before authentication according to the present invention;

FIG. 3 is a flowchart of the second preferred embodiment of a service method by granting authorization before authentication according to the present invention, illustrating a condition of successful authentication;

FIG. 4 is a flowchart of the second preferred embodiment, illustrating a condition of failed authentication;

FIG. 5 is a flowchart of the third preferred embodiment of a service method by granting authorization before authentication according to the present invention, illustrating a condition of successful authentication; and

FIG. 6 is a flowchart of the third preferred embodiment, illustrating a condition of failed authentication.

### BEST MODE FOR CARRYING OUT THE INVENTION

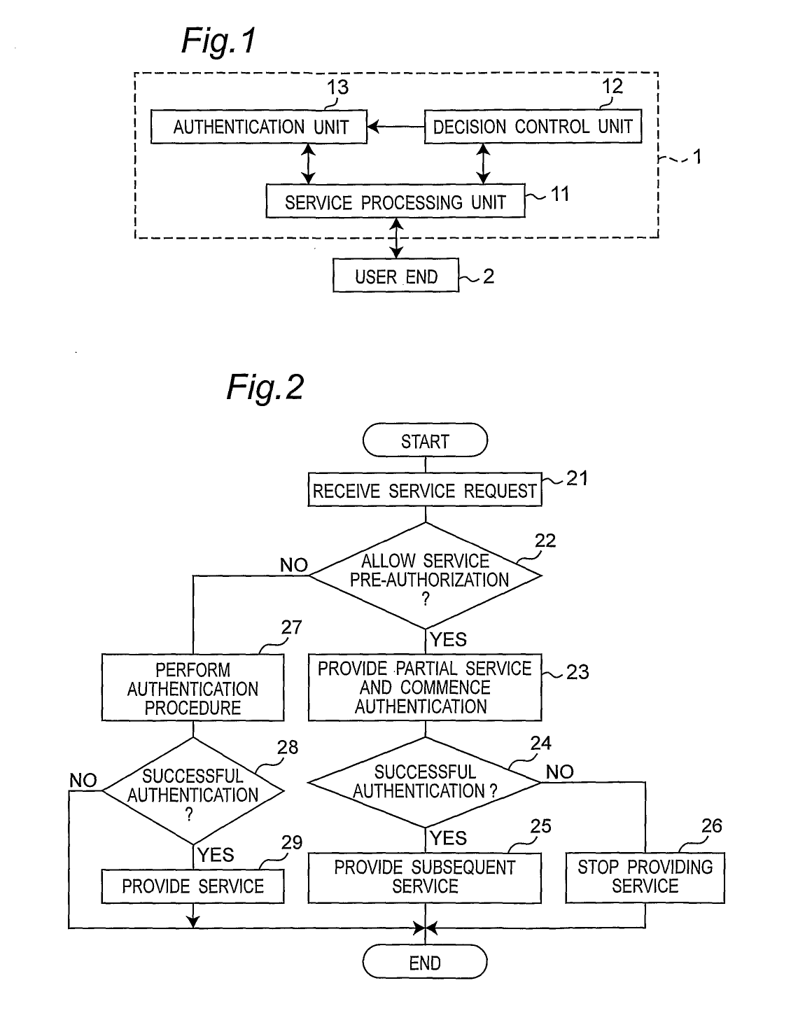

Referring to FIG. 1, the first preferred embodiment of a service apparatus by granting authorization before authentication according to the present invention is to be disclosed in a server end 1, and includes a service processing unit 11, a decision control unit 12, and an authentication unit 13.

The server end 1 is a service (information) provider. In this embodiment, the server end 1 communicates with a user end 2 in a wired (for example, a network) or wireless manner. According to a service request issued by the user end 2, the server end 1 provides a corresponding service to the user end 2. Taking room services in a hotel as an example, the server end 1 can include services, such as room door access control, pay films, pay music, pay channels, etc. Whether these services comply with a pre-authorization condition are decided by the decision control unit 12, and are preset in the decision control unit 12. For example, room door access control (instantaneous service) is a service that does not allow pre-authorization, whereas providing pay films, pay music and pay channels (non-instantaneous services) are services that allow pre-authorization. In this embodiment, the user end 2 can be a door access card reader interface or a playback device for films, music, channels, etc.

Therefore, as shown in step 21 in FIG. 2, when the service processing unit 11 receives a service request sent from the user end 2, where the service request further includes authentication data (such as door access card number, or user account number, password, etc.) for proving the user's identity, the service request will be relayed to the decision control unit 12. Next, as shown in step 22 in FIG. 2, the decision control unit 12 determines whether the service request calls for a service that allows pre-authorization, such as when the service request is for requesting viewing of pay channels or films, in accordance with the aforesaid preset pre-authorization condition. If affirmative, the flow proceeds to step 23 in FIG. 2, where the decision control unit 12 issues a pre-authorization command to the service processing unit 11 so as to provide a partial service to the user end 2, in which a portion of film content is first transmitted or pay channel access is first granted for viewing by the user. At the same time, the decision control unit 12 issues an authentication command to the authentication unit 13 so that the authentication unit 13 proceeds with authentication of the authentication information of the service request. Therefore, while the authentication process is being performed by the server end 1, there is no need for waiting by the user end 2, and the user end 2 can quickly receive service provided by the server end 1. Moreover, since the service processing unit 11 provides the partial service, under the condition that the identity of the user has yet to be fully confirmed, in order to have a distinction between the partial service provided at this time and subsequent service provided after identity confirmation, the service processing unit 11 is able to lower down the service quality of the partial service, for instance, picture quality of pay channels or films is worse than normal.

Then, as shown in step 24 in FIG. 2, after the authentication unit 13 has completed authentication and confirmed that the authentication information of the user is correct, the authentication unit 13 issues a successful authentication message to the service processing unit 11. The flow subsequently goes to step 25, where subsequent service with complete (normal) quality is further provided to the user end 2, such as the picture quality of pay channels or films is restored to normal. On the other hand, as shown in step 26, when the authentication information failed to pass authentication by the authentication unit 13, the authentication unit 13 issues a failed authentication message to the service processing unit 11 so as to stop providing service to the user end 2, such as stopping film playback or blocking pay channels.

Moreover, as shown in step 22, when the decision control unit 12 determines that the service request received from the service processing unit 11 is for a service that does not allow pre-authorization, such as a door access request service, pre-authorization will not be given to the service request, and the flow goes through steps 27 to 29, which performs a conventional authentication process where the authentication information of the service request is first sent to the authentication unit 13. Door access service is provided only after successful authentication.

Therefore, it is apparent from the first preferred embodiment that this invention can be applied to a server end 1 that provides multiple service items. A pre-authorization condition is preset in the decision control unit 12, and the decision control unit 12 determines whether a service request sent from the user end 2 to the service processing unit 11 calls for a service that allows pre-authorization. If affirmative, this indicates that the service request sent from the user end 2 calls for a service where partial access is possible without affecting security, and the service processing unit 11 is commanded to first provide partial service (which is pre-authorized) to the user end 2 simultaneous with confirmation of user identity by the authentication unit 13. Therefore, under the condition that the computing capability of the server end is not strong enough or a relatively long amount of time is needed for authentication, this embodiment can quickly provide service to valid users, can effectively shorten the time spent by the user in waiting for authentication, and the response to providing service becomes faster.

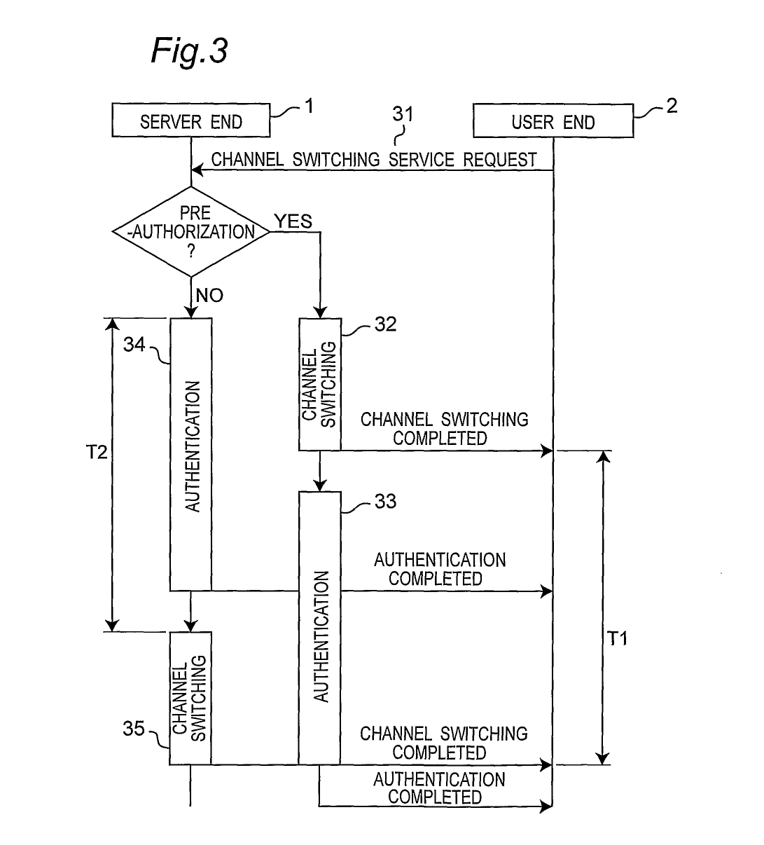

FIG. 3 illustrates the second preferred embodiment of this invention, which differs from the first preferred embodiment in that the server end 1 is a provider of continuous services. As such, the decision control unit 12 does not determine pre-authorization on the basis of a service request for an instantaneous service or continuous service, but instead determines pre-authorization based on other preset conditions. For instance, pre-authorization is granted if the user that issued the service request is a member, and is not granted if otherwise.

In the following, the server end 1 is exemplified as providing pay channel service and, with reference to FIG. 1 and FIGS. 3 and 4, the differences between services with and without pre-authorization will be described and compared hereinafter.

As shown in step 31 in FIG. 3, when the decision control unit 12 of the server end 1 receives a channel switching (that is, switching to a pay channel) service request from the user end 2, the decision control unit 12 determines whether pre-authorization is to be granted to the service request based on the preset conditions. Therefore, if the decision control unit 12 decides to grant pre-authorization, as shown in step 32, the decision control unit 12 first commands the service processing unit 11 to proceed with channel switching so as to give the user access to a pay channel. Thereafter, in step 33, the decision control unit 12 commands the authentication unit 13 to proceed with an authentication process. As such, the user end 2 does not need to wait for an authentication time period (T1) and can first enjoy the service. After authentication is completed, use of the pay channel is continued, and there is no need to be concerned with when the authentication process will be completed.

On the other hand, when the decision control unit 12 decides not to grant pre-authorization to the service request of the user end 2, a conventional authentication process follows, as shown in step 34, where the authentication unit 13 is commanded to first proceed with authentication. After authentication is completed, the flow proceeds to step 35, so as to give the user end 2 access to a pay channel. Therefore, the user end 2 must wait for an authentication time period (T2).

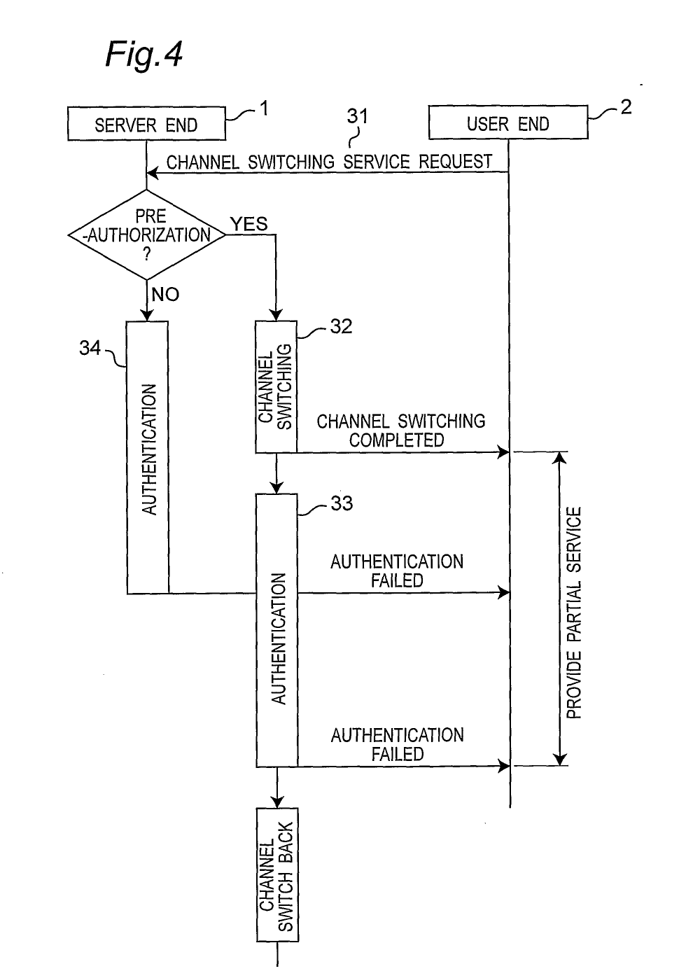

Moreover, as shown in FIG. 4, in the case that the decision control unit 12 granted pre-authorization to the service request of the user end 2, but authentication by the authentication unit 13 has failed, the authentication unit 13 notifies the service processing unit 11 to stop service, and withdraws the authority of the user end 2 in using the pay channel. When compared with not granting pre-authorization, although partial service has already been given to the user end 2 in the pre-authorization manner, the partial service thus provided does not cause any security loss to the server end 1, and has an effect of providing channel programs for the user end 2 to browse beforehand, and under the condition that the possibility of successful authentication is usually larger than that of failed authentication, pre-authorization offers benefits to either the server end 1 or the user end 2.

In the following, the server end 1 is exemplified as providing online film viewing service and, with reference to FIG. 1 and FIGS. 5 and 6, the differences between services with and without pre-authorization will be described and compared hereinafter.

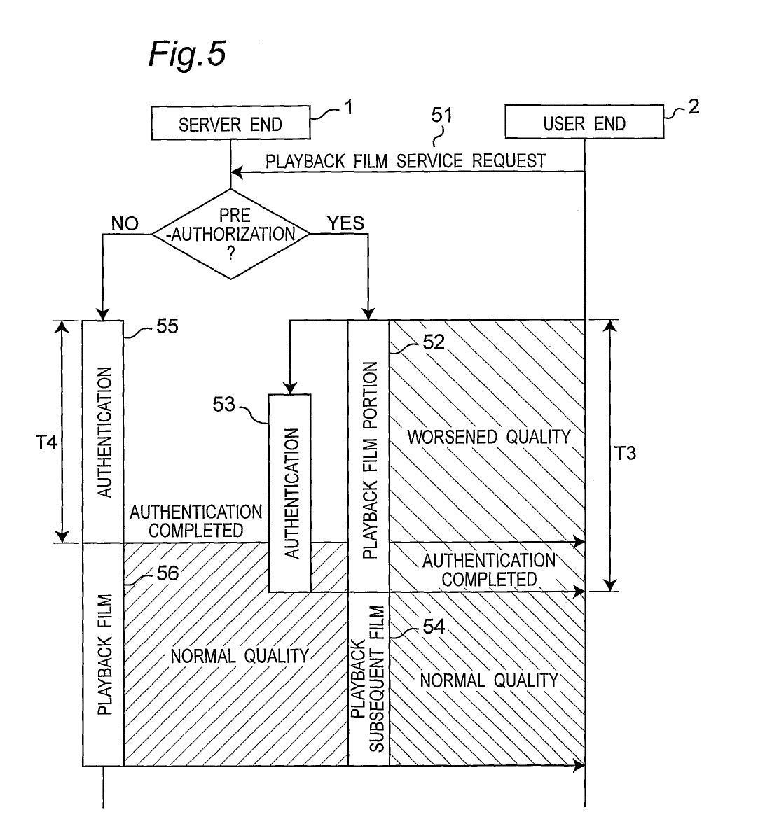

As shown in step 51 in FIG. 5, when the user end 2 issues a playback film service request to the server end 1, and the decision control unit 12 decides to grant pre-authorization to the user end 2, as shown in step 52, the decision control unit 12 then notifies the service processing unit 11 to first provide partial service to the user end 2, so as to begin playback of a film portion. During the process of film playback, as shown in step 53, the authentication unit 13 is simultaneously commanded to proceed with authentication of the authentication information of the service request. Since the identity of the user has yet to be fully confirmed at this time, the service processing unit 11 can, via an interference mechanism, cause the film being played back at this time to have a lower picture quality. After the authentication unit has confirmed successful authentication, the flow goes to step 54 for further playback of subsequent film having normal quality. Therefore, the user can enjoy service from the beginning and need not wait for an authentication time (T3).

On the other hand, when the decision control unit 12 decides not to grant pre-authorization to the service request of the user end 2, a conventional authentication process follows, as shown in steps 55 and 56, where film playback service is given to the user end 2 only after completing authentication of the service request. Therefore, the user must wait for an authentication time (T4).

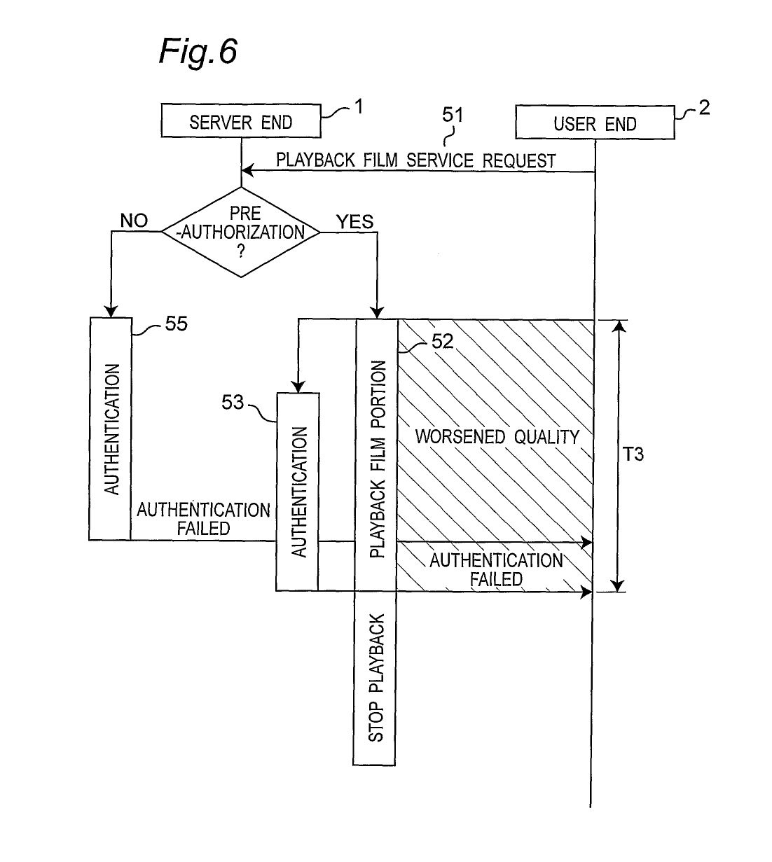

Similarly, as shown in FIG. 6, in the case that a pre-authorized service request failed to pass authentication, although the server end 1 has already provided a film portion to the user for viewing, this does not affect security or integrity of the service.

Moreover, it is worthwhile to note that, when the service processing unit 11 receives the same service request in succession, and pre-authorization service is provided through the decision control unit 12, but consecutive unsuccessful authentication of the service request by the authentication unit 13 has reached a predetermined number of times (such as thrice), the decision control unit 12 can cancel the pre-authorization authority of the service request, and classifies the service request as a non-pre-authorized service.

Additionally, the mechanism of granting authorization before authentication of this invention is further applicable to many other fields that require authentication. For example, if used in an optical disc recorder, when the optical disc recorder receives a service request for recording on an optical disc, the optical disc recorder can first determine whether the optical disc is a blank optical disc. If not a blank optical disc, pre-authorization recording is not granted. If a blank optical disc, pre-authorization is granted for recording on the optical disc. During the recording process, authentication of the service request is performed. If the authentication is successful, recording continues. If the authentication fails, recording is stopped, and data recorded beforehand is deleted.

In sum, this invention provides a pre-authorization mechanism for non-instantaneous services. Thus, simultaneous with authentication by a server end, partial service is first provided to a user. After completing authentication, subsequent service is further provided. Hence, the time spent by the user in waiting for authentication is shortened, and the time for providing service is more effective.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A service method by granting authorization before authentication, comprising:
(A) receiving a service request, the service request including authentication information;
(B) determining whether the service request calls for a service that allows pre-authorization; if affirmative, first providing a partial service and, simultaneous with providing the service, authenticating the authentication information; and
(C) upon successful authentication, further providing subsequent service; otherwise, stopping the service and rejecting the service request.

2. The service method by granting authorization before authentication as claimed in claim 1, wherein, in step (B), a pre-authorization condition is preset, and the partial service is provided when the service request complies with the pre-authorization condition.

3. The service method by granting authorization before authentication as claimed in claim 2, wherein, in step (B), the pre-authorization condition is directed to a service where all information is not instantaneously provided, and where a portion of service information can be provided first without affecting security.

4. The service method by granting authorization before authentication as claimed in claim 1, wherein the service request is directed to a service where all information is not instantaneously provided, and where a portion of service information can be provided first without affecting security.

5. The service method by granting authorization before authentication as claimed in claim 4, wherein, in step (B), a pre-authorization condition is preset, and the partial service is provided when the service request complies with the pre-authorization condition.

6. The service method by granting authorization before authentication as claimed in claim 5, wherein, in step (B), the pre-authorization condition can be set according to need.

7. The service method by granting authorization before authentication as claimed in claim 1, wherein, when a service request that allows pre-authorization is continuously received in step (A), but unsuccessful authentication of the service request has reached a predetermined number of times in step (B), the pre-authorization authority of the service request is withdrawn.

8. The service method by granting authorization before authentication as claimed in claim 1, wherein the service quality of the partial service provided in step (B) is worse than the service quality of the subsequent service provided in step (C).

9. A service apparatus by granting authorization before authentication, comprising:
a service processing unit for receiving a service request and for providing a corresponding service, wherein the service request includes authentication information;
an authentication unit connected to said service processing unit for authenticating the authentication information of the service request; and
a decision control unit connected to said service processing unit and said authentication unit, said decision control unit determining whether the service request calls for a service that allows pre-authorization, and if affirmative, commanding said service processing unit to first provide a partial service, simultaneously commanding said authentication unit to authenticate the authentication information, and commanding said service processing unit to further provide subsequent service upon successful authentication, and to stop the partial service and reject the service request if otherwise.

10. The service apparatus by granting authorization before authentication as claimed in claim 9, wherein a pre-authorization condition is preset in said decision control unit, and said decision control unit commands said service providing unit to first provide the partial service when the service request complies with the pre-authorization condition.

11. The service apparatus by granting authorization before authentication as claimed in claim 10, wherein the pre-authorization condition is directed to a service where all information is not instantaneously provided, and where a portion of service information can be provided first without affecting security.

12. The service apparatus by granting authorization before authentication as claimed in claim 9, wherein the service request is directed to a service where all information is not instantaneously provided, and where a portion of service information can be provided first without affecting security.

13. The service apparatus by granting authorization before authentication as claimed in claim 12, wherein a pre-authorization condition is preset in said decision control unit, and the partial service is provided when the service request complies with the pre-authorization condition.

14. The service apparatus by granting authorization before authentication as claimed in claim 13, wherein the pre-authorization condition can be set according to need.

15. The service apparatus by granting authorization before authentication as claimed in claim 9, wherein, when said service processing unit continuously receives a service request that allows pre-authorization, and unsuccessful authentication of the service request by said authentication unit has reached a predetermined number of times, said decision control unit withdraws the pre-authorization authority of the service request.

16. The service apparatus by granting authorization before authentication as claimed in claim 9, wherein the service quality of the partial service provided by said service processing unit is worse than the service quality of the subsequent service.

17. A service method by granting authorization before authentication for application to a service apparatus where full service is not provided at one time and where a partial service can be provided first without affecting security, the method comprising:
(A) receiving a service request, the service request including authentication information;
(B) first providing a partial service, and simultaneously authenticating the authentication information; and
(C) further providing subsequent service upon successful authentication, and stopping the partial service and rejecting the service request if otherwise.

18. The service method by granting authorization before authentication as claimed in claim 17, wherein, when a service request is continuously received in step (A), but unsuccessful authentication of the service request has reached a predetermined number of times in step (B), providing of the partial service is stopped.

19. The service method by granting authorization before authentication as claimed in claim 17, wherein the service quality of the partial service provided in step (B) is worse than the service quality of the subsequent service provided in step (C).
